(19) United States
(12) Patent Application Publication
(10) Pub. No.: US 2026/0134449 A1
(43) Pub. Date: May 14, 2026

(54) METHOD AND SYSTEM OF PERFORMING ADVERTISING ANALYTICS

(71) Applicant: HUAWEI TECHNOLOGIES CO., LTD., Shenzhen (CN)

(72) Inventors: Bora Caglayan, Dublin (IE); Mingxue Wang, Dublin (IE); Tong Gui, Nanjing (CN); Andrea Tonon, Dublin (IE); Fei Shen, Dongguan (CN)

(73) Assignee: HUAWEI TECHNOLOGIES CO., LTD., Shenzhen (CN)

(21) Appl. No.: 19/440,936

(22) Filed: Jan. 6, 2026

Related U.S. Application Data
(63) Continuation of application No. PCT/CN2023/137434, filed on Dec. 8, 2023.

(51) Int. Cl. G06Q 30/0242; G06F 16/34; G06Q 10/0639

(52) U.S. Cl. CPC G06Q 30/0242; G06F 16/345; G06Q 10/06393

(57) ABSTRACT

A method of performing advertising analytics is provided. The method includes (i) receiving as an input advertising campaign data for a completed advertising campaign, (ii) inputting the received advertising campaign data into a first data processing module which produces extracted root cause dimension combinations, (iii) inputting the output data set into a second data processing module that extracts explainability metrics of the extracted root cause dimension combinations, (iv) inputting the output data set into a third data processing module which creates an output filtered data set, (v) inputting the output filtered data set into a fourth data processing module which maps the root cause dimension combinations to natural language labels, and (vi) embedding the output filtered data set, the explainability metrics of the extracted root cause dimension combinations, and the natural language labels into a natural language template.

### CROSS-REFERENCE TO RELATED APPLICATIONS

This application is a continuation of International Application No. PCT/CN2023/137434, filed on Dec. 8, 2023, the disclosures of the aforementioned applications are hereby incorporated by reference in their entireties.

### TECHNICAL FIELD

The disclosure generally relates to advertising analytics, and more particularly, the disclosure relates to a method and a system of performing advertising analytics.

### BACKGROUND

Advertising diagnostic tools provide a set of customer metrics and dashboards for advertisers or users to analyze and understand root causes, RC's, of a performance of an advertisement campaign. The advertising diagnostic tools are used by the advertisers to measure the performance of their advertisement campaign. The advertisement campaign includes dimensions that collectively contribute to the performance of the advertisement campaign. The performance of the advertisement campaign is measured against key performance indicators, KPIs, and the dimensions of the advertisement campaign. The KPIs may be Return on Investment, ROI, Click-Through Rate, CTR, or Conversion Rate. The advertising diagnostic tools provide basic dashboard features and an analytical framework using aggregated KPIs of the advertisement campaign to the users. The dashboard features may include the KPIs, visualizations, and summaries that provide a quick snapshot of the performance of the advertisement campaign. The advertising diagnostic tools require business analysts to manually assess or measure a result of the root causes of the performance of the advertisement campaign and produce a report using layman's terms. This manual process is not only prone to errors but is also time-consuming. If there is any delay in delivering the report of the root causes of the performance of the advertisement campaign during quarterly or semi-annually advertisement campaign reviews, it results in revenue losses. Using advertising diagnostic tools to analyze multiple combinations of one or more dimensions that impact the KPIs can be challenging, especially when working on tasks like advertisement campaigns or monitoring cloud services. Additionally, searching for multiple dimension combinations in these advertising diagnostic tools to pinpoint the root causes for managing advertisement campaigns or monitoring cloud services can be time-consuming. For example, if there are 5 dimensions in the advertisement campaign, the advertising diagnostic tools find all possible root cause combinations out of those 5 dimensions by searching 2\hat{ }50 combinations using a brute-force search to manage the advertisement campaign or to monitor the cloud services. The advertising diagnostic tools would be exceedingly time-consuming and impractical due to the immense number of combinations, i.e., 2\hat{ }50 combinations, involved in the search.

An existing root cause analysis, RCA, tool is used to identify problems in a system, which gathers operational data, and categorizes the operational data based on dimensions and their corresponding values to pinpoint issues. The operational data includes the dimensions and their associated values within the system. The existing root cause analysis tool uses a data arrangement system to establish associations between changes in the dimensions and their corresponding values for each categorized operational data and changes in at least one KPI of the system. This is done to understand how the dimensions affect the overall system performance. Furthermore, the existing root cause analysis tool identifies a sensitive factor that is related to changes in the dimensions and corresponding values in each categorized operation data, as well as changes in the at least one KPI. This analysis helps in understanding how changes in each categorized operation data affect at least one KPI. The existing root cause analysis tool uses a root cause summarizer to identify root causes for the problem based on analysis of how changes in the operation data affect the at least one KPI. The existing root cause analysis tool also provides information on how distribution of value of the at least one KPI is different from the expected behavior of the system. The existing root cause analysis tool applies domain-expert rules on the suggested root cause to validate the identified root cause of the problem. The existing root cause analysis tool provides a list of all possible root causes of the problem based on the severity of the problem in the system. The existing root cause analysis tool does not determine why changes in the dimensions and corresponding values of each categorized operation data affect the at least one KPI or determine the reasons behind the changes in the values of the dimensions of each categorized operation data affect the at least one KPI, nor determine the reasons behind the suggested root cause that affect the at least one KPI. Additionally, the existing root cause analysis tool does not suggest any solutions to address the identified root cause of the problem.

An existing advertisement campaign system uses a Cross-Metric Multi-Dimensional, CMMD, root cause analysis method for monitoring and analyzing a conversion rate of KPIs to assess an efficacy of an advertisement campaign. This existing advertisement campaign system analyzes the dimensions of the advertisement campaign and detects any anomalies or deviations from an expected performance of the advertisement campaign. The CMMD root cause analysis method analyzes a combination of values of the dimensions and filters the dimensions that are the reasons for the anomalies. Here, the anomaly means the conversion rate drops in the KPIs of the advertisement campaign. This existing advertisement campaign system filters the combination of values of the dimensions to obtain a set of candidates that may have caused the anomaly, for use in a genetic algorithm. The existing advertisement campaign system filters the combination of values of the dimensions because not all combinations of values of the dimensions are abnormal when the anomaly is detected in the advertisement campaign. The CMMD root cause analysis method does not detail a process of generating a summary of the root cause, which means the reasons behind the anomaly that affects a performance of the advertisement campaign are not clear.

An existing video clip processing method for filtering content in an advertisement campaign is based on user preferences. The existing video clip processing method uses a dimensionality reduction algorithm to obtain dimensionality reduction features from the high-dimensional data of the advertisement campaign. This means that important features of the high-dimensional data are retained by removing unimportant features based on user preferences. Subsequently, the dimensionality reduction algorithm performs processing on video features to obtain the dimensionality reduction features. The existing video clip processing method does not disclose any other features.

Another existing incident management system monitors enterprise operations to identify anomalies in the enterprise operations. The existing incident management system includes an incident cause analysis sub-module that analyzes a root cause associated with incidents of the enterprise operations recognized to identify anomalies in the enterprise operations. i.e., the existing incident management system collects data of the enterprise operations and identifies log messages and key performance indicator, KPI, metrics related to the enterprise operations. The existing incident management system uses hierarchical clustering for obtaining flat clusters of the log messages with similar templates based on a linkage matrix defined in the hierarchical clustering to identify the anomalies in the enterprise operations. The existing incident management system includes an incident recognition module that generates an incident description for user interpretation based on an analysis of the root cause associated with the incidents using an incident cause description submodule and an incident recognition summarization model. The existing incident management system does not disclose extracting dimension combinations related to the root cause. Also, the existing incident management system does not disclose about a process of generating a summary specifically for high-severity cases of the root cause.

Another existing root cause analysis method uses a machine multi-classification model to classify and assess the dimensionality reduction data. The machine multi-classification model classifies the dimensionality reduction data into different categories. The existing root cause analysis method does not disclose extracting a root cause dimension.

Therefore, there arises a need to address the aforementioned technical problem/drawbacks of performing advertising analytics.

### SUMMARY

It is an object of the disclosure to provide a method and system of performing advertising analytics while avoiding one or more disadvantages of prior art approaches.

This object is achieved by the features of the independent claims. Further, implementation forms are apparent from the dependent claims, the description, and the figures.

According to a first aspect, there is a method of performing advertising analytics. The method includes receiving as an input advertising campaign data for a completed advertising campaign. The input advertising campaign data including at least one key performance indicator, KPI, data for all dimension combinations for one or more data snapshots. A snapshot is a summary of the KPI for each dimension combination for a time interval. The method includes inputting the received advertising campaign data for all dimension combinations into a first data processing module which implements a dimensional inference algorithm, which processes the received advertising campaign data for all dimension combinations and produces an output data set includes a reduced number of dimension combinations which are extracted root cause dimension combinations. The method includes inputting the output data set into a second data processing module which implements an explainability metric extraction algorithm, which processes the output data set and extracts explainability metrics of the extracted root cause dimension combinations. The method includes inputting the output data set into a third data processing module which implements a root cause dimension combination filter which filters the extracted root cause dimension combinations using the explainability metrics of the extracted root cause dimension combinations to create an output filtered data set. The method includes inputting the output filtered data set into a fourth data processing module which implements a natural language domain mapping algorithm which maps the filtered root cause dimension combinations to natural language labels. The method includes embedding the output filtered data set, the explainability metrics of the extracted root cause dimension combinations, and the natural language labels into a natural language template. The method includes creating, using a fifth data processing module, a root cause summarization diagnostic report, using natural language processing using the natural language template. The root cause summarization diagnostic report includes an explanation of an effect of the filtered data set of dimension combinations on at least one key performance indicator that was included in the advertising campaign data.

This method eliminates a need for manual data analysis with automated dimension combination analysis that helps a user to easily understand an impact of all dimension combinations on key performance indicators, KPIs, of the advertising campaign data. This method efficiently identifies the reduced number of root cause dimension combinations from a large number of dimension combinations of the advertising campaign data in a shorter time without large memory resources. This method improves a dimension analysis capability of the advertisement campaign by drilling down the reduced number of dimension combinations, i.e., this method filters the extracted root cause dimension combinations based on predetermined thresholds to categorize the extracted root cause dimension combinations into different severity levels using the dimensional inference algorithm. This method generates the root cause summarization diagnostic report that provides a clear and concise explanation for changes in a particular KPI, such as advertising revenue, by defining the explainability metrics of root cause dimension combinations. The root cause summarization diagnostic report is accurate and is a human-readable report as this method combines the explainability metrics of the extracted root cause dimension combinations, the natural language labels, and the filtered root cause dimension combinations into the natural language template. This method highlights severe changes of at least one KPI data in the summarization diagnostic report based on categorized severity levels. This method categorizes all dimension combinations of large data sets of the advertising campaign automatically using the dimensional inference algorithm, i.e., all dimension combinations of the large data sets are categorized into the root cause dimension combinations without a domain expert.

Optionally, the at least one KPI data is advertising revenue.

Preferably, the root cause summarization diagnostic report generated is in natural language laymen's terms.

Preferably, the root cause summarization diagnostic report is generated automatically.

Optionally, the one or more data snapshots consists of two data snapshots.

Preferably, the explainability metrics include a percentage of change for a dimension combination compared to an overall KPI.

Preferably, the explainability metrics include an absolute value of a percentage change for a particular dimension combination.

Preferably, the natural language domain mapping algorithm uses a dictionary of domain specific details used within reports used within an organization to which the advertising campaign data relates.

According to a second aspect, there is provided a system including means adapted for carrying out all the steps of the method.

According to a third aspect, a computer program includes instructions for performing the method when the computer program is executed on a computer system.

Therefore, in contradistinction to the existing solutions, a method and system of performing advertising analytics identify reduced root cause dimension combinations for the at least one KPI data from a large number of dimension combinations of the advertising campaign data in less time with less memory resources, thereby, the performance of the advertising campaign is increased.

These and other aspects of the disclosure will be apparent from the embodiment(s) described below.

### BRIEF DESCRIPTION OF DRAWINGS

Implementations of the disclosure will now be described, by way of example only, with reference to the accompanying drawings, in which:

FIG. 1 illustrates an architecture of a system for performing advertising analytics in accordance with an embodiment of the disclosure;

FIG. 2 illustrates an exemplary diagram of root cause summarization diagnostic report that is generated by a fifth data processing module of FIG. 1 for a decrease in overall mobile phone sales in accordance with an embodiment of the disclosure;

FIGS. 3A and 3B are flow diagrams that illustrate a method of performing advertising analytics in accordance with an embodiment of the disclosure; and

FIG. 4 is an illustration of a computer system (e.g., a first data processing module, a second data processing module, a third data processing module, a fourth data processing module, and a fifth data processing module) in which the various architectures and functionalities of the various previous embodiments may be implemented.

### DETAILED DESCRIPTION OF THE DRAWINGS

Embodiments of the disclosure provide a method and a system for performing advertising analytics.

To make solutions of the disclosure more comprehensible for a person skilled in the art, the following embodiments of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

### Definitions

Explainability is a concept that a model and its output can be explained in a way that “makes sense” to a human being at an acceptable level.

A category is a category dimension that is of interest to the advertisement domain experts for segmenting snapshot data.

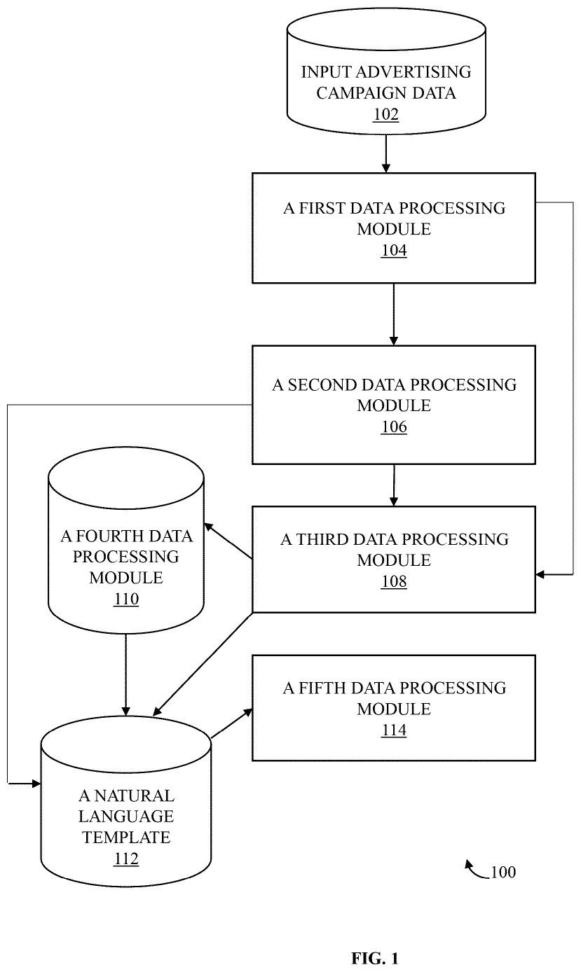

FIG. 1 illustrates an architecture of a system 100 performing advertising analytics in accordance with an implementation of the disclosure. The architecture of the system 100 includes a first data processing module 104, a second data processing module 106, a third data processing module 108, a fourth data processing module 110, and a fifth data processing module 114. The system 100 receives an input advertising campaign data 102 for a completed advertising campaign from an advertiser through a user device. The input advertising campaign data 102 includes at least one key performance indicator, KPI, data, and their values for all dimension combinations for one or more data snapshots. The one or more data snapshots may include two snapshots. The at least one KPI data associated with a business metric may be an advertising revenue. The snapshot is a summary of the KPI for each dimension combination for a time interval.

The first data processing module 104 receives the input advertising campaign data 102. The first data processing module 104 implements a dimensional inference algorithm that processes the received advertising campaign data for all dimension combinations. The dimensional inference algorithm processes the received advertising campaign data by checking a combination count of columns in the advertising campaign data of the completed advertising campaign. The dimensional inference algorithm infers root cause dimension combinations from all dimension combinations of the advertising campaign data by (i) checking a category limit of all dimension combinations or different dimension combinations in the advertising campaign data based on criteria to obtain candidate columns from all dimension combinations, and (ii) checking subdimensions for each candidate column in the advertising campaign data to determine category dimensions from all dimension combinations of the advertising campaign data. The candidate columns are root cause columns.

Preferably, the criteria are (i) 90% of the at least one KPI data for all dimension combinations should be in a range of 2<=x<UPPER_LIMIT categories, and (ii) if any dimension combinations in all dimensional combinations fall outside of the range, it is considered an outlier. The dimensional inference algorithm may place these dimension combinations into a separate column labeled as “others”, in cases where these dimension combinations occur infrequently or may be indicative of a typo error in the advertising campaign data.

The dimensional inference algorithm checks the subdimensions for each candidate column of the advertising campaign data by (i) selecting at least one column, for example, column C, from the candidate columns where a number of unique values or cardinality falls within a predefined threshold by applying the dimensional inference algorithm on each candidate column within the one or more snapshots, (ii) identifying column combinations in the candidate columns of the advertising campaign data by checking which number of unique values in the column C relates to the values in the other columns of the candidate columns, and (iii) computing a difference between each column combination to obtain a candidate score for each column combination, i.e. difference between the number of unique values in the column C and the number of unique values found in other columns of the candidate columns. The candidate score for each column combination may be a minimum or maximum. The dimensional inference algorithm identifies the column combinations with the lowest candidate score, i.e., the column combinations with the minimum mean score. These identified column combinations are referred to as inferred columns, indicating the category dimensions or a reduced number of dimension combinations. The first data processing module 104 produces an output data set including the reduced number of dimension combinations which are extracted root cause dimension combinations by running a root cause analysis algorithm per category.

Pseudocode for a dimensional inference algorithm is shown below. If the predefined threshold or upper bound is count 10, the dimensional inference algorithm selects the at least one column, for example, column C, from the candidate columns where the number of unique values or cardinality falls within the predefined threshold value 10, which are shown in the below-mentioned pseudocode:

```
Result: Inferred Category
candidates = [ ];
// check if number of categories are too high
for column in RC_Columns do
  if 2 <= (values with 90%+ of KPI) <= UPPER_BOUND then
    candidates.append(column);
end
for c in candidates do
  // u is the unique values in the candidate column
  unique_combinations = 0);
  for u in c do
    unique_combinations.add(unique_values(x for x in RC_Columns if x != c));
  end
  candidate_score[c] = mean (Σ_{i, j, i≠j} (Uᵢ − Uⱼ));
Inferred Category = argmin(candidate_score);
return Inferred Category
```

For example, if an input from a user is a log of search engine queries, the dimensions of the log of search engine queries are search keyword, language, or search engine. The dimensional inference algorithm automatically infers the category dimensions for the log of search engine queries by (i) eliminating the search keyword dimension as the number of unique values in at least one column of the advertising campaign data falls within the predefined thresholds, (ii) eliminating the language dimension because search tags (i.e., search engine queries) are different per language, (iii) selecting the search engine dimension as the category dimension because the search keyword dimension and the language dimension are similar for both fling and Google, i.e., when analyzing the root cause of issues related to the log of search engine queries on the search engines, the differences in keywords and languages may not be as significant as the differences between the search engines themselves.

Table: 1 illustrates “search engine” dimension associated with the category dimension or the root cause dimension combinations.

TABLE 1

| Search engine | Keyword | Language |
|---|---|---|
| Bing | Computer | En |
| Bing | Desk | En |
| Google | [symbol] | Zh |
| Google | [symbol] | Zh |
| Google | [symbol] | Zh |
| Bing | desk | En |
| Google | phone | En |

The second data processing module 106 receives the extracted root cause dimension combinations from the first data processing module 104. The second data processing module 106 implements an explainability metric extraction algorithm to extract explainability metrics of the extracted root cause dimension combinations using the value of an overall or the at least one KPI data and the value of a root cause KPI data at the two snapshots or two different intervals. The explainability metrics of the extracted root cause dimension combinations define changes in the root cause dimension combinations of the advertising campaign data that impact overall contributions to the at least one KPI data of the completed advertising campaign.

The explainability metrics are used in understanding the root causes and variations in the at least one KPI data through a percentage of change contributed to the overall target KPI change by dimension combination. The explainability metric names are as follows:
PKDC: Percentage of change contributed to the overall target KPI change by dimension combination.
CC: Absolute Percentage change of the dimension combination.
FRAC: Percentage Fraction of dimension combination KPI over overall KPI at snapshot T1.

For calculating the PKDC, CC, and FRAC, the explainability metric extraction algorithm utilizes the value of the at least one KPI data at time1 is denoted as S1, the value of the overall KPI data at time2 is denoted as S2, the value of the root cause KPI data at time1 is denoted as S3 and the value of the root cause KPI data at time2 is denoted as S4.

The PKDC is calculated by measuring a percentage change in the extracted root cause dimension combinations between the two snapshots (S3 and S4) compared to the percentage change in the overall KPI data between two other snapshots (S1 and S2). This comparison is used to calculate the change in the root cause dimension combinations relative to the change in the overall KPI data. The PKDC can be greater than 100% if multiple dimensions within the extracted root cause dimension combinations change in opposite directions.

$$PKDC = 100 ⋆ ( S 4 - S 3 ) / ( S 2 - S 1 )$$

The absolute percentage change in the extracted root cause dimension combinations represents how dramatic the change is for the extracted root cause dimension combinations between the two snapshots (S3 and S4). A small CC indicates low relative change.

$$CC = 100 ⋆ ( S 4 - S 3 ) / S 3$$

The FRAC represents how much the at least one KPI data of the extracted root cause dimension combinations at S4 contributes to the overall KPI data at S2.

$$FRAC = 100 ⋆ S 4 / S 2$$

If the FRAC is low, it means that the extracted root cause dimension combinations represent some KPIs from the overall KPI data. If the FRAC is high, it means that the extracted root cause dimension combinations represent nearly all KPI data from the overall KPI data.

The third data processing module 108 receives the extracted root cause dimension combinations or the category dimensions from the first data processing module 104, and the explainability metrics of the extracted root cause dimension combinations from the second data processing module 106. The third data processing module 108 selects a root cause drilldown algorithm or a root cause dimension combination filter based on the at least one KPI data of the completed advertising campaign after receiving the extracted root cause dimension combinations or the category dimensions.

The below pseudocode outlines a root cause drilldown algorithm, executed per category, for specifying the root cause from root cause dimension combinations for changes in a particular KPI of the completed advertising campaign:

```
function RCA (pt, cat, snapshotₜ₁, snapshotₜ₂, md);
Input: potential score threshold: pt, category: cat, snapshot for first interval:
    snapshotₜ₁, snapshot for second interval: snapshotₜ₂, md: max depth
Output: best dimension combination for category
// we transform the snapshot to sparse array with auto
  accumulating columns
cuboids = transformToSparseArray(snapshotₜ₁, cat),
    transformToSparseArray(snapshotₜ₂, cat);
// contains all the cuboids from 1D to ND
possible DimensionCombinations = dimensionCombinationGenerator(snapshotₜ₁);
candidates = [ ];
for dc in possible DimensionCombinations do
    depth = 0;
    while depth <md do
      monteCarlos TreeSarch(dc);
      depth += 1;
      if potentialScore(candidate) <= pt then
        candidates.append(candidate)[ ];
        break;
// now we pick the best candidate
topCandidate = None:
// we pick the candidate with the smallest subsection of
  data since it has high specificity
minCandidateSpace = +inf;
for cand in candidates do
    if span(cand); minCandidateSpace then
      minCandidateSpace = span(cand);
      topCandidate = cand;
return topCandidate
```

The root cause dimension combination filter filters the extracted root cause dimension combinations based on the explainability metrics of the extracted root cause dimension combinations and predetermined thresholds to create an output filtered data set. The root cause dimension combination filter filters the extracted root cause dimension combinations based on the severity level of the category dimensions or the extracted root cause dimension combinations. The filtered root cause dimension combinations are considered as the root cause due to the filtered root cause dimension combinations meeting predetermined thresholds. The predetermined thresholds are (i) the extracted root cause dimension combinations contribute at least 50% to the PKDC, i.e., PKDC (>=50%), or (ii) the extracted root cause dimension combinations contribute at least 30% to the CC, i.e., CC (>=30%), or (iii) the extracted root cause dimension combinations contribute above 50% to the FRAC, i.e., FRAC (<=50%). The third data processing module 108 produces the output-filtered data set. The output filtered data set is filtered root cause dimension combinations.

The fourth data processing module 110 receives the filtered root cause dimension combinations from the third data processing module 108. The fourth data processing module 110 implements a natural language domain mapping algorithm. The natural language domain mapping algorithm maps the filtered root cause dimension combinations to natural language labels. The explainability metrics of the extracted root cause dimension combinations of results of the second data processing module 106, the natural language labels of results of the fourth data processing module 110, and the filtered root cause dimension combinations of results of the third data processing module 108 are embedded into a natural language template 112. The fifth data processing module 114 receives the natural language template 112. The fifth data processing module 114 generates a root cause summarization diagnostic report of the completed advertising campaign using the natural language template 112. Preferably, the fifth data processing module 114 generates the root cause summarization diagnostic report automatically. The fifth data processing module 114 generates the root cause summarization diagnostic report with natural language laymen's terms.

The natural language domain mapping algorithm may use a dictionary of domain-specific details used within reports i.e., organization reports within an organization, relevant to the completed advertising campaign. For example, zone 1 might be associated with Europe, and the natural language terms may be used in the root cause summarization diagnostic report of the completed advertising campaign.

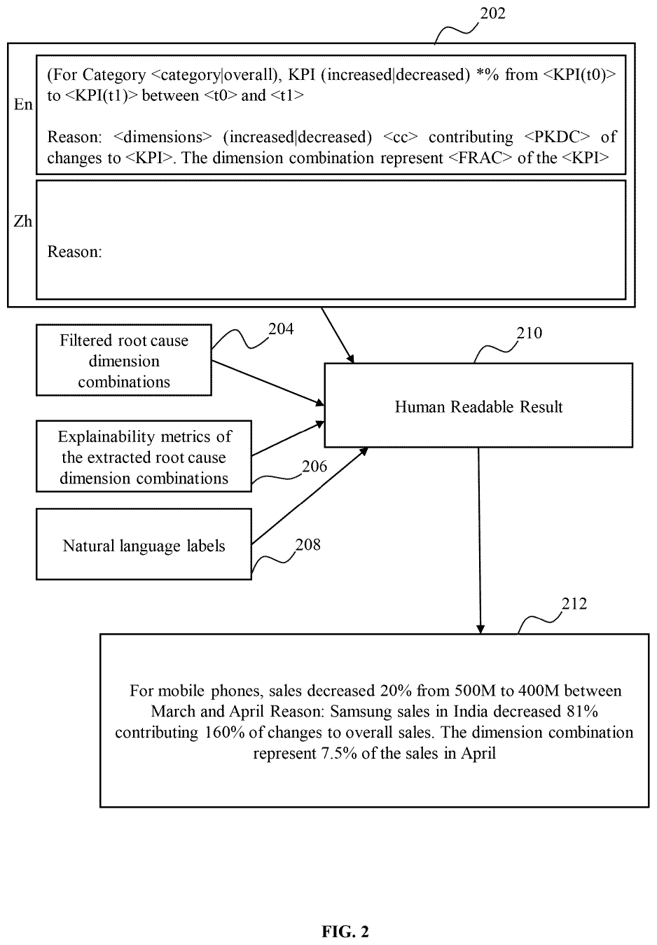

FIG. 2 illustrates an exemplary diagram of a root cause summarization diagnostic report that is generated by the fifth data processing module of FIG. 1 for a decrease in overall mobile phone sales in accordance with an implementation of the disclosure. The fifth data processing module generates a human-readable result 210 for the decrease in the overall mobile phone sales using natural language labels 208. The human readable result 210 is generated based on explainability metrics of extracted root cause dimension combinations 206, and filtered root cause dimension combinations 204 using a natural language template 202 in English, en, and in Chinese, zh (not shown in FIG. 2). The natural language template is in a predefined format in human language. For example, the natural language template in English is “(For Category <category|overall), KPI (increased|decreased) *% from <KPI(t0)> to <KPI(t1)> between <t0> and <t1>

Reason: <dimensions> (increased|decreased)<cc> contributing <PKDC> of changes to <KPI>. The dimension combination represents <FRAC> of the <KPI>”

The category may be mobile phones. The KPI may be sales. The reason for the decreased sales of overall mobile phones is that 7.5% of Samsung sales in India decreased by 81% contributing 160% of changes to overall sales. The reason for the decreased sales of overall mobile phones may be determined based on the filtered root cause dimension combinations 204, and the explainability metrics of the extracted root cause dimension combinations 206.

The filtered root cause dimension combinations 204, and the explainability metrics of the extracted root cause dimension combinations 206 for the decrease in the overall mobile phone sales are embedded into the natural language template 202 using the natural language labels 208. A fourth data processing module of FIG. 1 uses the natural language labels 208 to generate a label in a form of phrases that explain the filtered root cause dimension combinations 204 contributing to the decrease in the overall mobile phone sales. The human-readable result 210 is the root cause summarization diagnostic report of the overall decreased sales of mobile phones. For example, mobile phone sales decreased 20% from 500 million to 400 million between March and April. The overall mobile phone sales (i.e., dimension combination) was 7.5% in April, and the reason for the 7.5% is Samsung sales in India decreased by 81% contributing 160% of changes to overall sales., as depicted in 212.

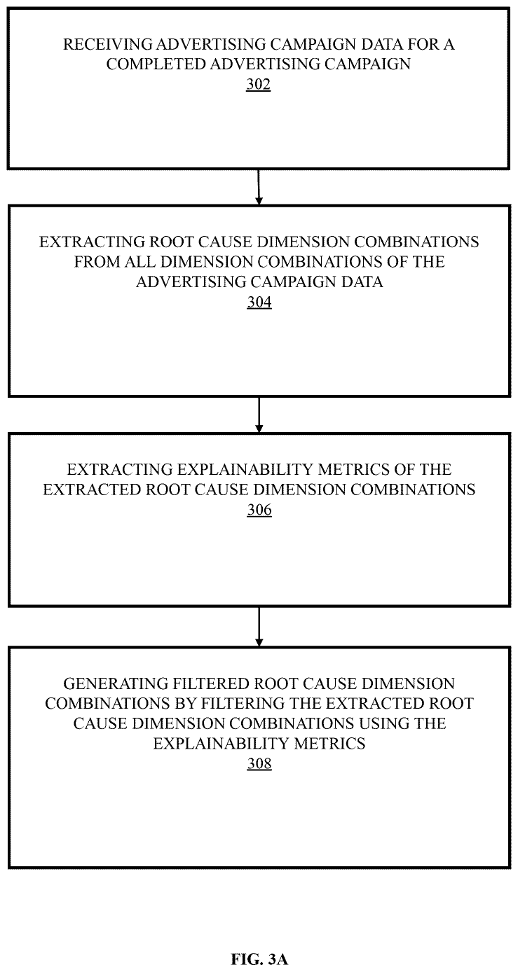

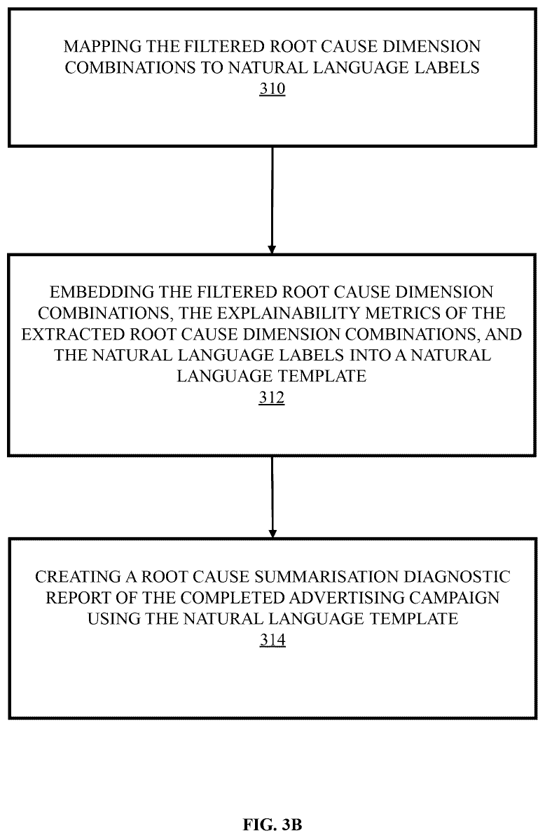

FIGS. 3A and 3B are flow diagrams that illustrate a method of performing advertising analytics in accordance with an implementation of the disclosure. Turning first to FIG. 3A, at a step 302, the method includes receiving advertising campaign data for a completed advertising campaign. The advertising campaign data includes at least one key performance indicator, KPI, data for all dimension combinations for one or more data snapshots. A snapshot is a summary of a key performance indicator for each dimension combination for a time interval. At a step 304, the method includes producing a reduced number of dimension combinations which are extracted root cause dimension combinations from all dimension combinations of the advertising campaign data in the first data processing module. The first data processing module implements a dimensional inference algorithm that processes the advertising campaign data for all dimension combinations. At a step 306, the method includes extracting explainability metrics of the extracted root cause dimension combinations in the second data processing module. The second data processing module implements an explainability metric extraction algorithm that processes the extracted root cause dimension combinations to extract the explainability metrics of the extracted root cause dimension combinations. At a step 308, the method includes generating filtered root cause dimension combinations by filtering the extracted root cause dimension combinations using the explainability metrics of the extracted root cause dimension combinations in the third data processing module. The third data processing module implements a root cause dimension combination filter that filters the extracted root cause dimension combinations. Turning to FIG. 3B, at a step 310, the method includes mapping filtered root cause dimension combinations in the fourth data processing module to the natural language labels. The fourth data processing module implements a natural language domain mapping algorithm to map the filtered root cause dimension combinations to the natural language labels. At a step 312, the method includes embedding the filtered root cause dimension combinations, the explainability metrics of the extracted root cause dimension combinations, and the natural language labels into a natural language template. At a step 314, the method includes creating a root cause summarization diagnostic report of the completed advertising campaign using the natural language template in the fifth data processing module. The fifth data processing module implements natural language processing to create the root cause summarization diagnostic report. The root cause summarization diagnostic report includes an explanation of an effect of the filtered data set of dimension combinations on at least one key performance indicator that was included in the advertising campaign data.

In an implementation, a computer program product comprises program instructions for performing the method, when executed by one or more processors in a system.

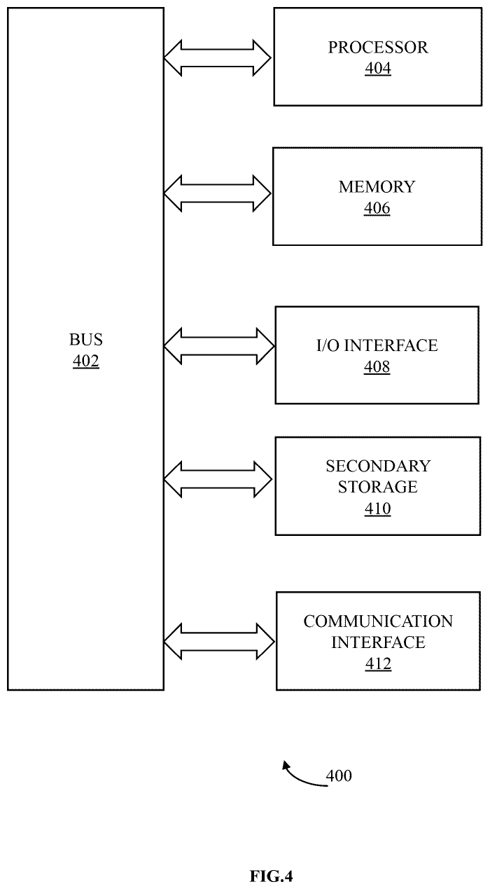

FIG. 4 is an illustration of a computer system (e.g., a first data processing module, a second data processing module, a third data processing module, a fourth data processing module, and a fifth data processing module) in which the various architectures and functionalities of the various previous implementations may be implemented. As shown, the computer system 400 includes at least one processor 403 that is connected to a bus 402, wherein the computer system 400 may be implemented using any suitable protocol, such as Peripheral Component Interconnect, PCI-Express, Accelerated Graphics Port, AGP, Hyper Transport, or any other bus or point-to-point communication protocol. The computer system 400 also includes a memory 406.

Control logic (software) and data are stored in the memory 406 which may take a form of random-access memory, RAM. In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit, CPU and bus implementation. Of course, the various modules may also be situated separately or in various combinations of semiconductor platforms per the desires of the user.

The computer system 400 may also include a secondary storage 410. The secondary storage 410 includes, for example, a hard disk drive and a removable storage drive, representing a floppy disk drive, a magnetic tape drive, a compact disk drive, digital versatile disk, DVD drive, recording device, universal serial bus, USB flash memory. The removable storage drive at least one of reads from and writes to a removable storage unit in a well-known manner.

Computer programs, or computer control logic algorithms, may be stored in at least one of the memory 406 and the secondary storage 410. Such computer programs, when executed, enable the computer system 400 to perform various functions as described in the foregoing. The memory 406, the secondary storage 410, and any other storage are possible examples of computer-readable media.

In an implementation, the architectures and functionalities depicted in the various previous figures may be implemented in the context of the processor 404, a graphics processor coupled to a communication interface 412, an integrated circuit (not shown) that is capable of at least a portion of the capabilities of both the processor 404 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated to entertainment purposes, an application-specific system. For example, the computer system 400 may take the form of a desktop computer, a laptop computer, a server, a workstation, a game console, or an embedded system.

Furthermore, the computer system 400 may take the form of various other devices including, but not limited to a personal digital assistant, PDA device, a mobile phone device, a smart phone, a television, and so forth. Additionally, although not shown, the computer system 400 may be coupled to a network (for example, a telecommunications network, a local area network, LAN, a wireless network, a wide area network, WAN, such as the Internet, a peer-to-peer network, a cable network, or the like) for communication purposes through an I/O interface 408.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

What is claimed is:

1. A method of performing advertising analytics comprising steps, implemented using one or more hardware processors, of:
(a) receiving as an input advertising campaign data for a completed advertising campaign, including at least one key performance indicator, KPI, data for all dimension combinations for a plurality of data snapshots, wherein a snapshot is a summary of a key performance indicator for each dimension combination for a time interval;
(b) inputting the received advertising campaign data for all dimension combinations into a first data processing module which implements a dimensional inference algorithm, which processes the received advertising campaign data for all dimension combinations and produces an output data set comprising a reduced number of dimension combinations which are extracted root cause dimension combinations;
(c) inputting the output data set resulting from step (b) into a second data processing module which implements an explainability metric extraction algorithm, which processes the output data set from step (b) and extracts explainability metrics of the extracted root cause dimension combinations;
(d) inputting the output data set resulting from step (b) into a third data processing module which implements a root cause dimension combination filter which filters the extracted root cause dimension combinations using the metrics extracted at step (c) to create an output filtered data set;
(e) inputting the output filtered data set resulting from step (d) into a fourth data processing module which implements a natural language domain mapping algorithm which maps the filtered root cause dimension combinations to natural language labels;
(f) embedding the output filtered data set resulting from step (d), the explainability metrics resulting from step (c), and the natural language labels resulting from step(e) into a natural language template; and
(g) using the natural language template to create, using a fifth data processing module, a root cause summarization diagnostic report, using natural language processing, wherein the root cause summarization diagnostic report includes an explanation of an effect of the filtered data set of dimension combinations on at least one key performance indicator that was included in the advertising campaign data of step (a).

2. The method of claim 1, wherein the at least one KPI data is advertising revenue.

3. The method of claim 1, wherein the root cause summarization diagnostic report generated at step (g) is in natural language laymen's terms.

4. The method of claim 3, wherein the root cause summarization diagnostic report is generated automatically.

5. The method of claim 1, wherein the plurality of data snapshots consists of two data snapshots.

6. The method of claim 1, wherein the explainability metrics include a percentage of change for a dimension combination compared to an overall KPI.

7. The method of claim 1, wherein the explainability metrics include an absolute value of a percentage change for a particular dimension combination.

8. The method of claim 1, wherein the natural language domain mapping algorithm uses a dictionary of domain specific details used within reports used within an organization to which the advertising campaign data relates.

9. A system for performing advertising analytics, the system comprises:
one or more processors, one or more memories, and one or more programs, wherein the one or more programs are stored in the one or more memories, the one or more programs comprise instructions, and when the instructions are executed by the one or more processors, the system is enabled to:
(a) receiving as an input advertising campaign data for a completed advertising campaign, including at least one key performance indicator, KPI, data for all dimension combinations for a plurality of data snapshots, wherein a snapshot is a summary of a key performance indicator for each dimension combination for a time interval;
(b) inputting the received advertising campaign data for all dimension combinations into a first data processing module which implements a dimensional inference algorithm, which processes the received advertising campaign data for all dimension combinations and produces an output data set comprising a reduced number of dimension combinations which are extracted root cause dimension combinations;
(c) inputting the output data set resulting from step (b) into a second data processing module which implements an explainability metric extraction algorithm, which processes the output data set from step (b) and extracts explainability metrics of the extracted root cause dimension combinations;
(d) inputting the output data set resulting from step (b) into a third data processing module which implements a root cause dimension combination filter which filters the extracted root cause dimension combinations using the metrics extracted at step (c) to create an output filtered data set;
(e) inputting the output filtered data set resulting from step (d) into a fourth data processing module which implements a natural language domain mapping algorithm which maps the filtered root cause dimension combinations to natural language labels;
(f) embedding the output filtered data set resulting from step (d), the explainability metrics resulting from step (c), and the natural language labels resulting from step(e) into a natural language template; and
(g) using the natural language template to create, using a fifth data processing module, a root cause summarization diagnostic report, using natural language processing, wherein the root cause summarization diagnostic report includes an explanation of an effect of the filtered data set of dimension combinations on at least one key performance indicator that was included in the advertising campaign data of step (a).

10. The system of claim 9, wherein the at least one KPI data is advertising revenue.

11. The system of claim 9, wherein the root cause summarization diagnostic report generated at step (g) is in natural language laymen's terms.

12. The system of claim 11, wherein the root cause summarization diagnostic report is generated automatically.

13. The system of claim 9, wherein the plurality of data snapshots consists of two data snapshots.

14. The system of claim 9, wherein the explainability metrics include a percentage of change for a dimension combination compared to an overall KPI.

15. The system of claim 9, wherein the explainability metrics include an absolute value of a percentage change for a particular dimension combination.

16. The system of claim 9, wherein the natural language domain mapping algorithm uses a dictionary of domain specific details used within reports used within an organization to which the advertising campaign data relates.

17. A computer program comprising computer-executable instructions stored on a non-transitory computer-readable medium that, when executed by a processor, cause a device to:
(a) receiving as an input advertising campaign data for a completed advertising campaign, including at least one key performance indicator, KPI, data for all dimension combinations for a plurality of data snapshots, wherein a snapshot is a summary of a key performance indicator for each dimension combination for a time interval;
(b) inputting the received advertising campaign data for all dimension combinations into a first data processing module which implements a dimensional inference algorithm, which processes the received advertising campaign data for all dimension combinations and produces an output data set comprising a reduced number of dimension combinations which are extracted root cause dimension combinations;
(c) inputting the output data set resulting from step (b) into a second data processing module which implements an explainability metric extraction algorithm, which processes the output data set from step (b) and extracts explainability metrics of the extracted root cause dimension combinations;
(d) inputting the output data set resulting from step (b) into a third data processing module which implements a root cause dimension combination filter which filters the extracted root cause dimension combinations using the metrics extracted at step (c) to create an output filtered data set;
(e) inputting the output filtered data set resulting from step (d) into a fourth data processing module which implements a natural language domain mapping algorithm which maps the filtered root cause dimension combinations to natural language labels;
(f) embedding the output filtered data set resulting from step (d), the explainability metrics resulting from step (c), and the natural language labels resulting from step(e) into a natural language template; and
(g) using the natural language template to create, using a fifth data processing module, a root cause summarization diagnostic report, using natural language processing, wherein the root cause summarization diagnostic report includes an explanation of an effect of the filtered data set of dimension combinations on at least one key performance indicator that was included in the advertising campaign data of step (a).

18. The computer program of claim 17, wherein the at least one KPI data is advertising revenue.

19. The computer program of claim 17, wherein the root cause summarization diagnostic report generated at step (g) is in natural language laymen's terms.

20. The computer program of claim 19, wherein the root cause summarization diagnostic report is generated automatically.
